(19) United States
(12) Patent Application Publication
(10) Pub. No.: US 2025/0300811 A1
(43) Pub. Date: Sep. 25, 2025

(54) METHODS FOR MIGRATING PRIVATE HARDWARE SECURITY KEYS AND DEVICES THEREOF

(71) Applicant: F5, Inc., Seattle, WA (US)

(72) Inventors: Liang CHENG, Seattle, WA (US); Saxon C. AMDAHL, Seattle, WA (US); Andrey JIVSOV, Seattle, WA (US)

(73) Assignee: F5, Inc., Seattle, WA (US)

(21) Appl. No.: 18/146,082

(22) Filed: Dec. 23, 2022

(51) Int. Cl. H04L 9/08

(52) U.S. Cl. CPC H04L 9/0825; H04L 9/0822

(57) ABSTRACT

Methods, non-transitory computer readable media, network traffic manager apparatuses, and systems that assist with migrating keys between a first hardware security system and a second hardware security system includes receiving an encrypted symmetric key from a first hardware security system. The symmetric key generated by the first hardware security system is encrypted using a public key generated from a second hardware security system. A generated public key is sent to the first hardware security system prior to encrypting the symmetric key. The received encrypted symmetric key is sent to the second hardware security system. An encrypted original key from the first hardware security system is received upon sending the encrypted symmetric key to the second hardware security system. The original key is encrypted using the symmetric key. The migration is completed when the second hardware security system decrypts the sent encrypted original key using the sent encrypted symmetric key.

### FIELD

This technology relates to methods and systems for migrating private hardware security keys from one hardware security system to another hardware security system.

### BACKGROUND

A hardware security system, typically referred to as a hardware security module, is computer hardware and/or software (e.g., a computing device) configured to store cryptographic keys, perform cryptographic operations (such as generating keys, encrypting data, and decrypting data), and enforce a security policy for using and/or accessing the cryptographic keys.

The problem with hardware security systems is that different vendors or providers have different application programming interfaces (APIs) and methods for storing keys which can cause a challenge when it comes to migrating security hardware keys between different hardware security systems.

### SUMMARY

A method for migrating private hardware security keys from one hardware security system to another hardware security system, implemented in cooperation with a cloud service or a network traffic management system comprising one or more network traffic management modules, server modules, or client modules, includes receiving an encrypted symmetric key from a first hardware security system. The symmetric key generated by the first hardware security system is encrypted using a public key generated from a second hardware security system. A generated public key is sent to the first hardware security system prior to encrypting the symmetric key. The received encrypted symmetric key is sent to the second hardware security system. An encrypted original key from the first hardware security system is received upon sending the encrypted symmetric key to the second hardware security system. The original key is encrypted using the symmetric key. The migration is completed when the second hardware security system decrypts the sent encrypted original key using the sent encrypted symmetric key.

A network traffic management apparatus including memory including programmed instructions stored thereon and one or more processors configured to be capable of executing the stored programmed instructions to receive an encrypted symmetric key from a first hardware security system. The symmetric key generated by the first hardware security system is encrypted using a public key generated from a second hardware security system. A generated public key is sent to the first hardware security system prior to encrypting the symmetric key. The received encrypted symmetric key is sent to the second hardware security system. An encrypted original key from the first hardware security system is received upon sending the encrypted symmetric key to the second hardware security system. The original key is encrypted using the symmetric key. The migration is completed when the second hardware security system decrypts the sent encrypted original key using the sent encrypted symmetric key.

A non-transitory computer readable medium having stored thereon instructions for including executable code that, when executed by one or more processors, causes the processors to receive an encrypted symmetric key from a first hardware security system. The symmetric key generated by the first hardware security system is encrypted using a public key generated from a second hardware security system. A generated public key is sent to the first hardware security system prior to encrypting the symmetric key. The received encrypted symmetric key is sent to the second hardware security system. An encrypted original key from the first hardware security system is received upon sending the encrypted symmetric key to the second hardware security system. The original key is encrypted using the symmetric key. The migration is completed when the second hardware security system decrypts the sent encrypted original key using the sent encrypted symmetric key.

A network traffic management system includes one or more traffic management modules, server modules, or client modules, memory comprising programmed instructions stored thereon, and one or more processors configured to be capable of executing the stored programmed instructions to receive an encrypted symmetric key from a first hardware security system. The symmetric key generated by the first hardware security system is encrypted using a public key generated from a second hardware security system. A generated public key is sent to the first hardware security system prior to encrypting the symmetric key. The received encrypted symmetric key is sent to the second hardware security system. An encrypted original key from the first hardware security system is received upon sending the encrypted symmetric key to the second hardware security system. The original key is encrypted using the symmetric key. The migration is completed when the second hardware security system decrypts the sent encrypted original key using the sent encrypted symmetric key.

This technology provides a number of advantages including providing methods, non-transitory computer readable media, network traffic management apparatuses, and network traffic management systems that help support and orchestrate the plurality of hardware security systems on the backend, so that the same key is stored in different hardware security systems. This technology creates a method of encryption security of communications that can be used to increase security of a client-server architecture. Additionally, this technology advantageously provides key migrations from one hardware security system to another hardware security system without ever storing a private or unencrypted key in cleartext outside of the plurality of hardware security systems.

### BRIEF DESCRIPTION OF THE DRAWINGS

FIGS. 1A-1B are block diagrams of an exemplary network traffic management system with a network traffic management apparatus;

FIG. 2 is a block diagram of an exemplary network traffic manager apparatus;

FIG. 3 is a flowchart of an exemplary method for migration of hardware security keys;

FIG. 4A is an exemplary block diagram of an exemplary network traffic manager apparatus receiving a migration request from a client computing device;

FIG. 4B is an exemplary block diagram of an exemplary network traffic manager apparatus receiving a public hardware security key from a second hardware security system;

FIG. 4C is an exemplary block diagram of an exemplary network traffic manager apparatus sending a request to generate a symmetric key using the public hardware security key to a first hardware security system;

FIG. 4D is an exemplary block diagram of an exemplary network traffic manager apparatus receiving an encrypted symmetric key from a first hardware security system;

FIG. 4E is an exemplary block diagram of an exemplary network traffic manager apparatus sending the received encrypted symmetric key to a second hardware security system;

FIG. 4F is an exemplary block diagram of an exemplary network traffic manager apparatus sending a request to a first hardware security system to encrypt an original key using a symmetric key;

FIG. 4G is an exemplary block diagram of an exemplary network traffic manager apparatus receiving an encrypted original key from a first hardware security system;

FIG. 4H is an exemplary block diagram of an exemplary network traffic manager apparatus sending a received encrypted original key to a second hardware security system; and

FIG. 4I is an exemplary block diagram of an exemplary network traffic manager apparatus sending a decryption request to a second hardware security system to decrypt an encrypted original key with an encrypted symmetric key.

### DETAILED DESCRIPTION

This technology relates to key migrations from one hardware security system to another hardware security system without ever storing a private or unencrypted key in cleartext outside of the plurality of hardware security systems. This technology provides a key migration service that is external to the plurality of hardware security systems that can assist with the key migration. The key migration service can communicate with all hardware security systems provided by the major Cloud Providers. The key migration service is also secure because the service does not have the data required to decrypt the migrating keys, because the key migration does not have access to the private keys in the plurality of hardware security systems.

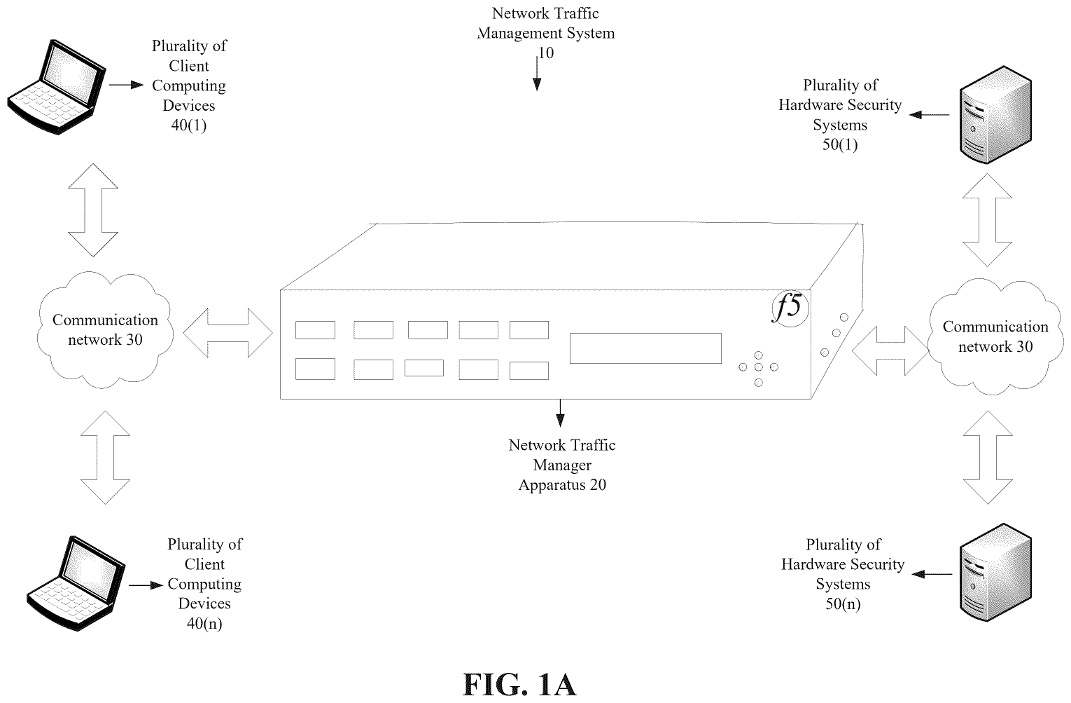

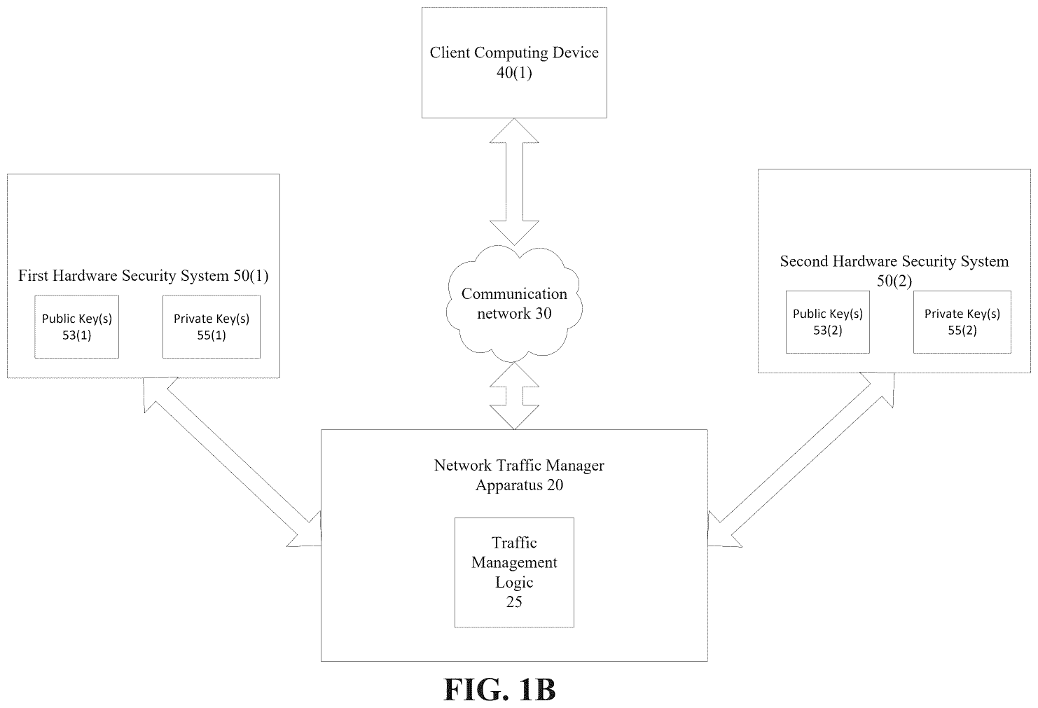

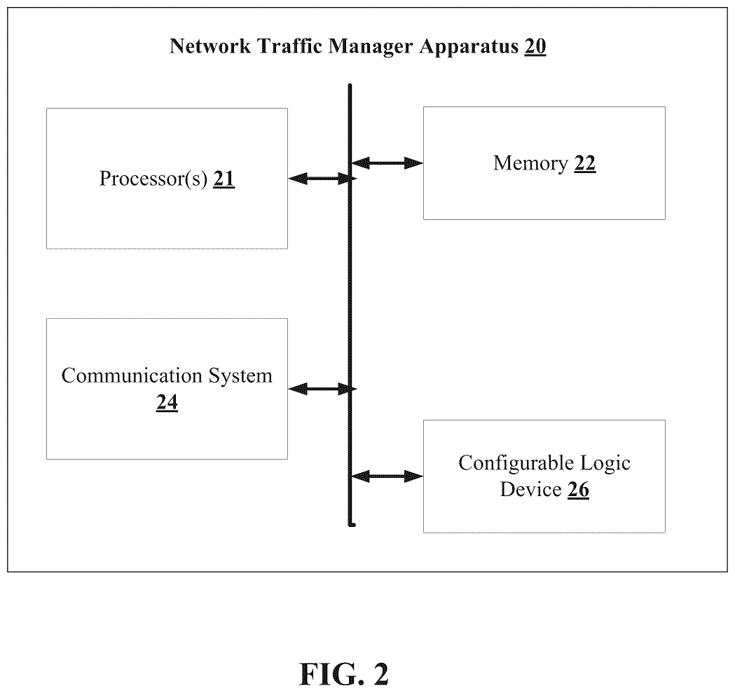

An example of this technology includes a network environment 10 with a network traffic manager apparatus 20 for migrating a private security hardware key is illustrated in FIGS. 1A, 1B, and 2. In this example, the environment 10 includes the network traffic manager apparatus 20, a plurality of client computing devices 40(1)-40(n), and the plurality of hardware security system(s) 50(1)-50(n) which are coupled together by communication networks 30, although the environment can include other types and numbers of systems, devices, components, and/or elements and in other topologies and deployments. While not shown, the exemplary environment 10 may include additional network components, such as routers, switches and other devices, which are well known to those of ordinary skill in the art and thus will not be described here.

Referring more specifically to FIGS. 1A and 1B, the network traffic manager apparatus 20 of the network traffic management system is coupled to the plurality of client computing devices 40(1)-40(n) through the communication network 30, although the plurality of client computing devices 40(1)-40(n) and network traffic manager apparatus 20 may be coupled together via other topologies. Additionally, the network traffic manager apparatus 20 is coupled to the plurality of hardware security system(s) 50(1)-50(n) through the communication network 30, although the plurality of hardware security system(s) 50(1)-50(n) and the network traffic manager apparatus 20 may be coupled together via other topologies. The network traffic manager apparatus 20 can be implemented using the architecture as described in more detail with reference to FIG. 2.

Referring to FIG. 1B, the figure depicts a block diagram of an example architecture that includes a client computing device 40(1) coupled together with a network traffic manager apparatus 20 via a communication network 30. The client computing device 40(1) can also be coupled together with a network traffic manager apparatus 20 using other topologies. FIG. 1B further illustrates how the network traffic manager apparatus 20 can perform cryptographic operations by using traffic management logic 25. In some embodiments, the network traffic manager apparatus 20 can be offloaded to a first hardware security system 50(1) and a second hardware security system 50(2). In some embodiments, the traffic management logic 25 can offload cryptographic operations by sending requests via a multi-threaded real-time software routine that interfaces with the first hardware security system 50(1) and the second hardware security system 50(2). The real-time software routine can process information with a time constraint in some non-limiting examples. The real-time software routine can communicate with the first hardware security system 50(1) and a second hardware security system 50(2) using different HSS sessions. A HSS session can be initiated by a thread by requesting that a session be opened on a particular token of the first hardware security system 50(1) and/or the second hardware security system 50(2). The first hardware security system 50(1) and/or the second hardware security system 50(2) can return a session handle for the session and the session handle can be used when requesting cryptographic operations to be performed by the first hardware security system 50(1) and/or the second hardware security system 50(2). The session handle and other information about the session can be stored in data structures. After a session for the thread is opened, the thread can be used to manage the cryptographic operations. In some embodiments, multiple threads can be used to perform multiple cryptographic operations concurrently on the first hardware security system 50(1) and/or the second hardware security system 50(2). The cryptographic operations can include generating a key, generating a key pair, encrypting a private key, decrypting an encrypted key, encrypting data using a key, decrypting data using a key, generating random or pseudo-random number, and other operations known in the art. In some embodiments, the first hardware security system 50(1) can include public key(s) 53(1) and private key(s) 55(1). In other embodiments, the second hardware security system 50(2) can include public key(s) 53(2) and private key(s) 55(2). FIG. 1B further illustrates how the network traffic manager apparatus 20 can use the traffic management logic 25 to perform the cryptographic operations with the public key(s) 53(1)-(2) and private keys(s) 55(1)-(2) of the first hardware security system 50(1) and the second hardware security system 50(2).

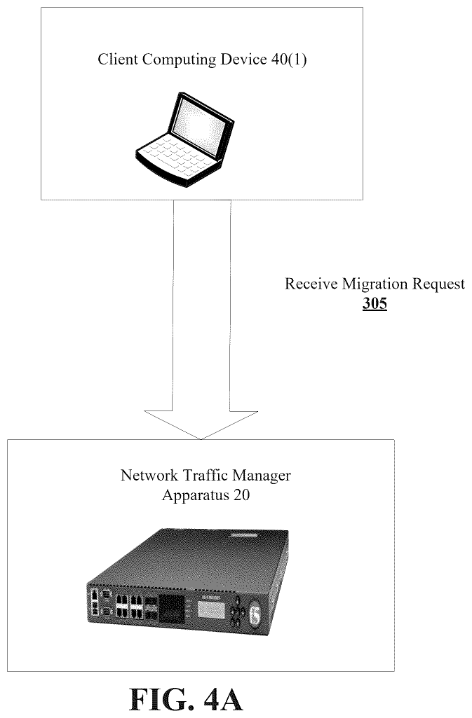

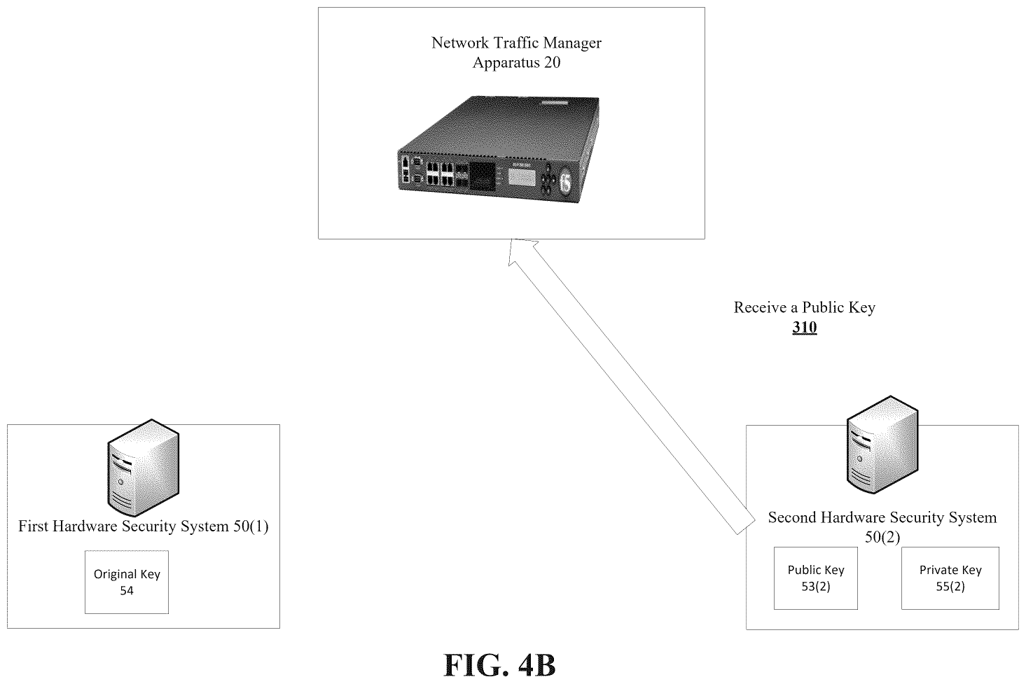

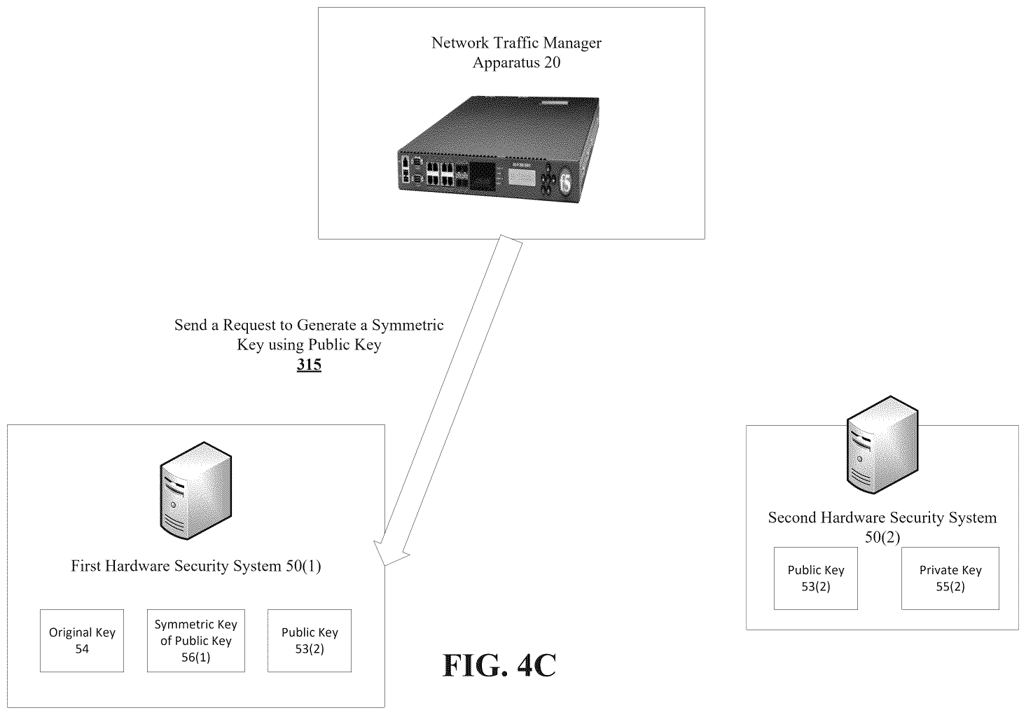

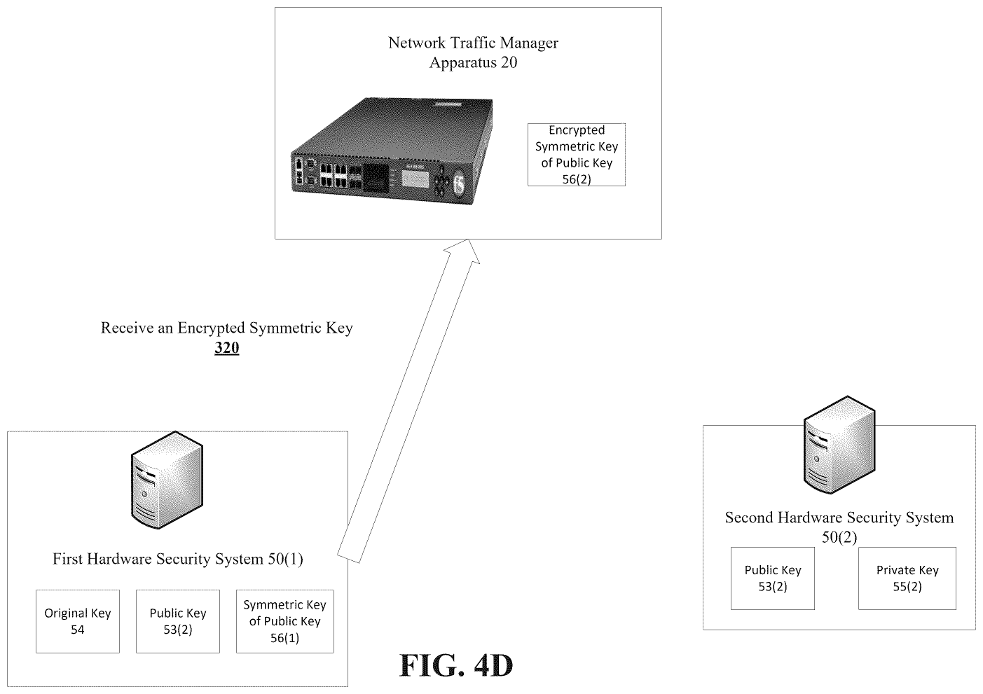

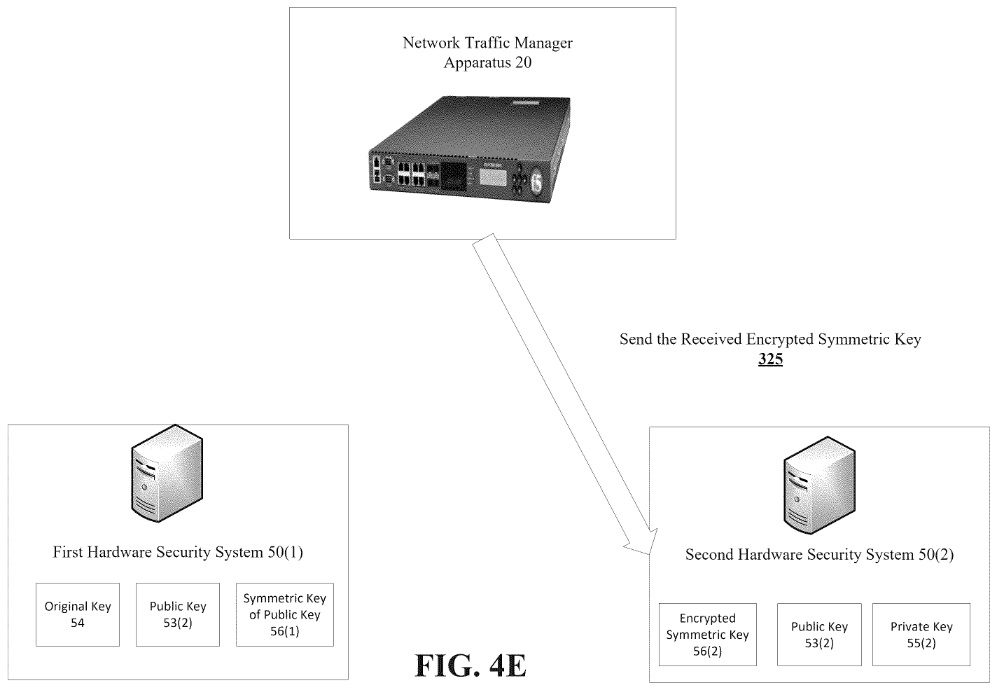

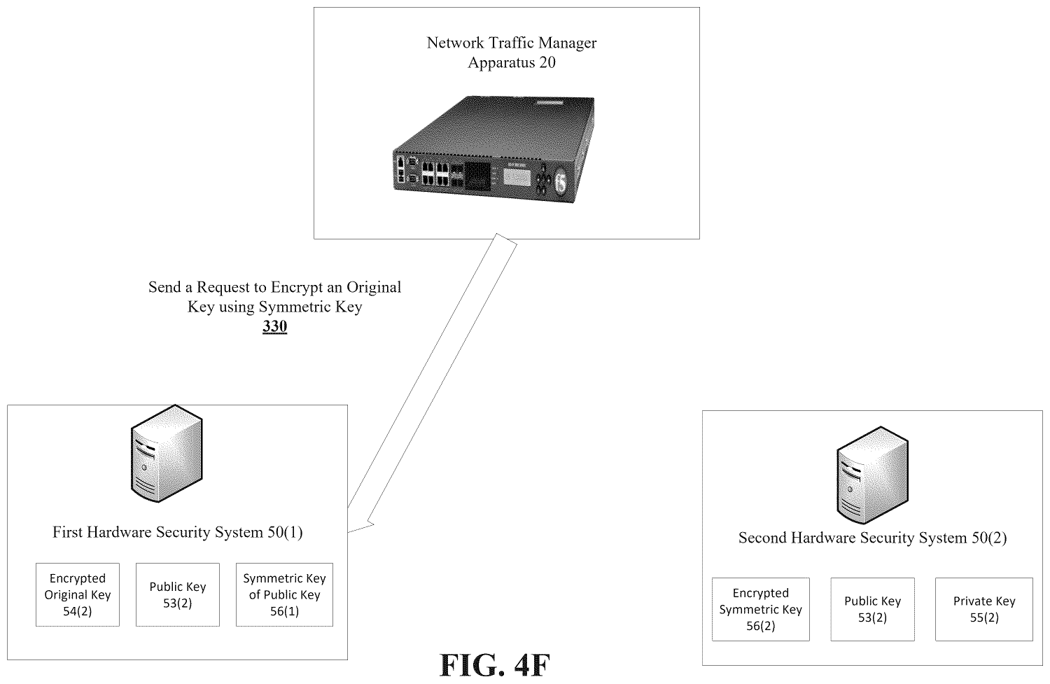

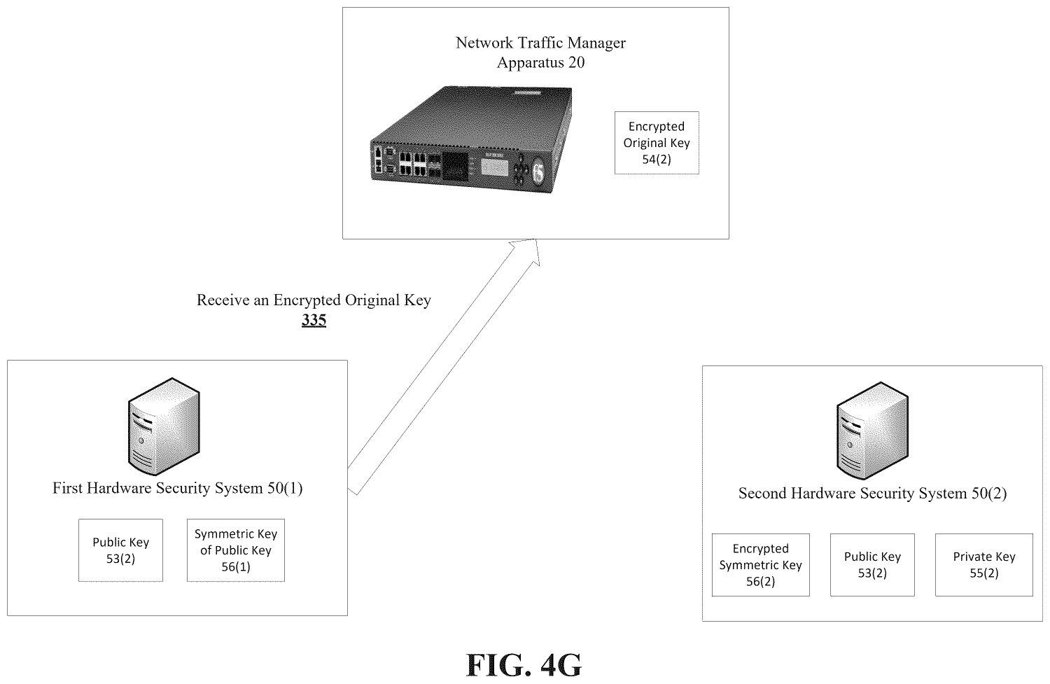

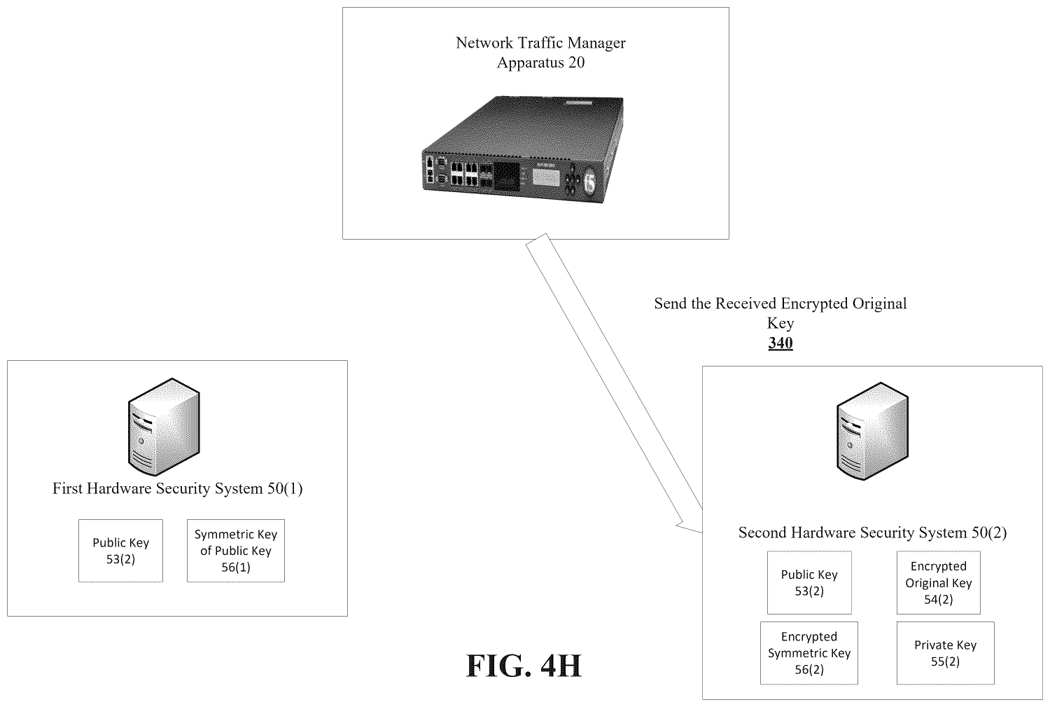

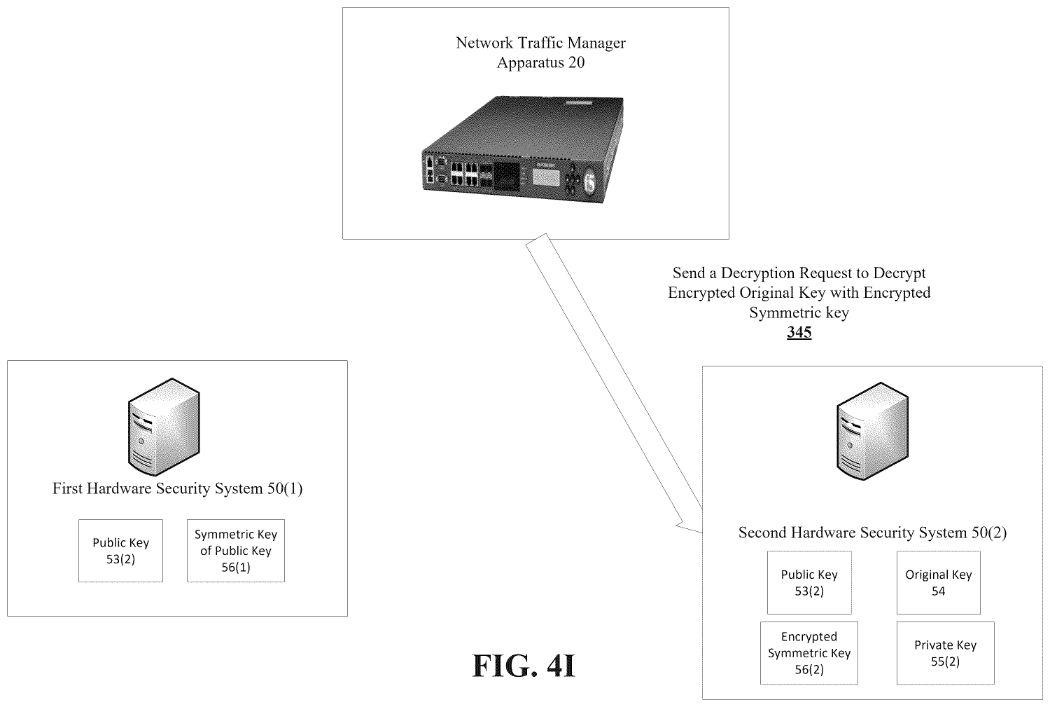

The network traffic manager apparatus 20 can also assist with migrating keys as illustrated and described by way of the examples herein, although the network traffic manager apparatus 20 may perform other types and/or numbers of functions. FIGS. 4A-4I illustrate cryptographic operations performed by the network traffic manager apparatus 20 to migrate an original key 54 from the first hardware security system 50(1) to the second hardware security system 50(2). It can be understood that the network traffic manager apparatus 20 can perform additional operations apart from the illustrated operations in FIGS. 4A-4I and can perform the same illustrated operations with a plurality of hardware security systems 50(1)-50(n). As illustrated in FIG. 2, the network traffic manager apparatus 20 includes processor 21 or central processing unit (CPU) 18, memory 22, optional configurable hardware logic 26, and a communication system 24 which are coupled together by a bus device 19 although the network traffic manager apparatus 20 may comprise other types and numbers of elements in other configurations. In this example, the bus 19 is a PCI Express bus in this example, although other bus types and links may be used.

The processors 18 within the network traffic manager apparatus 20 may execute one or more computer-executable instructions stored in memory 22 for the methods illustrated and described with reference to the examples herein, although the processor can execute other types and numbers of instructions and perform other types and numbers of operations. The processor 21 may comprise one or more central processing units (“CPUs”) or general purpose processors with one or more processing cores, such as AMD® processor(s), although other types of processor(s) could be used (e.g., Intel®).

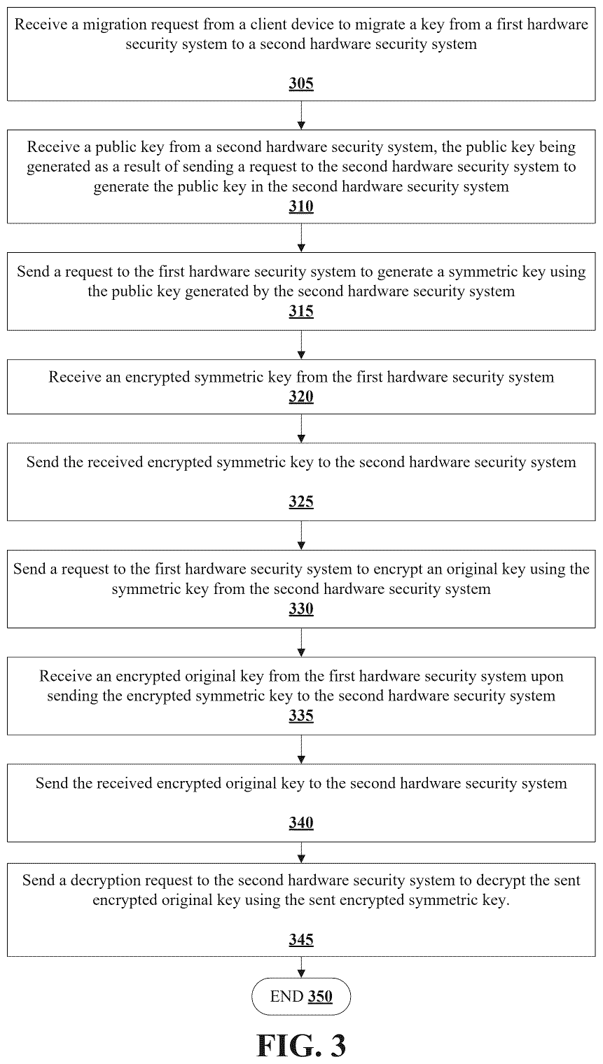

The memory 22 within the network traffic manager apparatus 20 may comprise one or more tangible storage media, such as RAM, ROM, flash memory, CD-ROM, floppy disk, hard disk drive(s), solid state memory, DVD, or any other memory storage types or devices, including combinations thereof, which are known to those of ordinary skill in the art. The memory 22 may store one or more non-transitory computer-readable instructions of this technology as illustrated and described with reference to the examples herein that may be executed by the processor 21. The exemplary flowchart shown in FIGS. 3 and 4A-4I are representative of example steps or actions of this technology that may be embodied or expressed as one or more non-transitory computer or machine readable instructions stored in the memory 22 that may be executed by the processor 21 and/or may be implemented by configured logic in the optional configurable logic 26.

Accordingly, the memory 22 of the network traffic manager apparatus 20 can store one or more applications that can include computer executable instructions that, when executed by the network traffic manager apparatus 20, causes the network traffic manager apparatus 20 to perform actions, such as to transmit, receive, or otherwise process messages, for example, and to perform other actions described and illustrated below with reference to FIGS. 3 and 4A-4I. The application(s) can be implemented as module or components of another application. Further, the application(s) can be implemented as operating system extensions, module, plugins, or the like. The application(s) can be implemented as module or components of another application. Further, the application(s) can be implemented as operating system extensions, module, plugins, or the like. Even further, the application(s) may be operative in a cloud-based computing environment. The application(s) can be executed within virtual machine(s) or virtual server(s) that may be managed in a cloud-based computing environment. Also, the application(s), including the network traffic manager apparatus 20 itself, may be located in virtual server(s) running in a cloud-based computing environment rather than being tied to one or more specific physical network computing devices. Also, the application(s) may be running in one or more virtual machines (VMs) executing on the network traffic manager apparatus 20. Additionally, in at least one of the various embodiments, virtual machine(s) running on the network traffic manager apparatus 20 may be managed or supervised by a hypervisor.

The optional configurable hardware logic device 26 in the network traffic manager apparatus 20 may comprise specialized hardware configured to implement one or more steps of this technology as illustrated and described with reference to the examples herein. By way of example only, the optional configurable logic hardware device 21 may comprise one or more of field programmable gate arrays (“FPGAs”), field programmable logic devices (“FPLDs”), application specific integrated circuits (ASICs “) and/or programmable logic units (“ PLUS”).

The network traffic manager apparatus 20 is used to operatively couple and communicate between the network traffic manager apparatus 20, the plurality of client computing devices 40(1)-40(n), and the plurality of hardware security system(s) 50(1)-50(n) which are all coupled together by communication network 30 such as one or more local area networks (LAN) and/or the wide area network (WAN), although other types and numbers of communication networks or systems with other types and numbers of connections and configurations to other devices and elements may be used. As illustrated in FIGS. 1B and 4A-4I, the network traffic manager apparatus 20 can be used to operatively couple and communicate between the network traffic manager apparatus 20, a client computing device 40(1), a first hardware security system 50(1) and a second hardware security system 50(2) which are also all coupled together by communication network 30 such as one or more LAN and/or WAN. By way of example only, the communication network such as local area networks (LAN) and the wide area network (WAN) can use TCP/IP over Ethernet and industry-standard protocols, including NFS, CIFS, SOAP. XML, LDAP, and SNMP, although other types and numbers of communication networks, can be used. In this example, the bus 26 is a PCI Express bus in this example, although other bus types and links may be used.

Each of the plurality of client computing devices 40(1)-40(n) of the network traffic management system 10, include a central processing unit (CPU) or processor, a memory, input/display device interface, configurable logic device and an input/output system or I/O system, which are coupled together by a bus or other link. Additionally, the plurality of client computing devices 40(1)-40(n) can include any type of computing device that can receive, render, and facilitate user interaction, such as client computers, network computer, mobile computers, mobile phones, virtual machines (including cloud-based computer), or the like. Each of the plurality of client computing devices 40(1)-40(n) utilizes the network traffic manager apparatus 20 to conduct one or more operations with the plurality of hardware security systems 50(1)-50(n), such as to obtain or create cryptographic keys, by way of example only, although other functions could also be performed as well. As depicted in FIGS. 1B and 4A, a client computing device 40(1) can send one or more operations through a network traffic manager apparatus 20 to a first hardware security system 50(1) and second hardware security system 50(2) via a communication network 30, although the plurality of client computing devices 40(1)-40(n) and network traffic manager apparatus 20 may be coupled together via other topologies.

Generally, the plurality of hardware security system(s) 50(1)-50(n) can perform various computing tasks that are implemented using a computing environment. The computing environment can include computer hardware, computer software, and combinations thereof. As a specific example, the computing environment can include general-purpose and/or special-purpose processor(s), configurable and/or hard-wired electronic circuitry, a communications interface, and computer-readable memory for storing computer-executable instructions to enable the processor(s) to perform a given computing task. The logic to perform a given task can be specified within a single module or interspersed among multiple modules. As used herein, the terms “module” and “component” can refer to an implementation within one or more dedicated hardware devices or apparatus (e.g., computer(s)), and/or an implementation within software hosted by one or more hardware devices or apparatus that may be hosting one or more other software applications or implementations. Additionally, the network traffic manager apparatus 20 can include a cryptographic offload module that is used to offload cryptographic operations to the plurality of hardware security system(s) 50(1)-50(n). The cryptographic offload module can be a software daemon executed by a processor 21 of the network traffic apparatus 20. A daemon is a software routine that runs as a background process and can use and schedule the aforementioned threads to manage the performance of the cryptographic operations on the plurality of hardware security system(s) 50(1)-50(n).

The plurality of hardware security system(s) 50(1)-50(n) can be implemented using various different computer architectures. For example, a plurality of hardware security system(s) 50(1)-50(n) can be implemented as a plug-in circuit card that interfaces to an input/output or peripheral interface (such as Peripheral Component Interconnect Express (PCIe)) of a computer and can include a connector for connecting to a backplane or other connector of the computer. As another example, a plurality of hardware security system(s) 50(1)-50(n) can be implemented as a computer appliance that is connected over a computer network (a network-based plurality of hardware security system(s) 50(1)-50(n)). As another example, a plurality of hardware security system(s) 50(1)-50(n) can be implemented as a virtualized resource within a cloud-computing infrastructure (a cloud-based plurality of hardware security system(s) 50(1)-50(n)). The plurality of hardware security system(s) 50(1)-50(n) can have different storage capacities and/or acceleration capabilities. For example, a physical plurality of hardware security system(s) 50(1)-50(n) can be divided into multiple logical plurality of hardware security system(s) 50(1)-50(n), where each logical plurality of hardware security system(s) 50(1)-50(n) can have different capabilities and can be accessed using different account credentials. A logical plurality of hardware security system(s) 50(1)-50(n) can also be referred to as a partition or token of the physical plurality of hardware security system(s) 50(1)-50(n). Partitions of the plurality of hardware security system(s) 50(1)-50(n) can be isolated from each other so that keys and data on one partition are not visible from a different partition. Partitions can share hardware and other resources or the partitions can use specific unshared hardware and resources. A plurality of hardware security system(s) 50(1)-50(n) can use various storage technologies, such as random-access memory (RAM), non-volatile RAM, FLASH memory, a hard-disk drive, a solid-state drive, or other storage implementations. A plurality of hardware security system(s) 50(1)-50(n) can enable and/or deny access to a key according to a security policy. For example, the security policy can specify that a particular key can only be used and/or accessed when authorized account credentials are presented to the plurality of hardware security system(s) 50(1)-50(n).

In one example, the network traffic manager apparatus 20 can be a dedicated computing device including a processor 21 and a computer-readable memory 22. The memory 22 of the network traffic management apparatus 810 can store one or more applications that can include computer-executable instructions that, when executed by the network traffic manager apparatus 20, cause the network traffic manager apparatus 20 to perform actions, such as to transmit, receive, or otherwise process messages, for example, and to perform other actions such as, offloading cryptographic operations to the plurality of hardware security system(s) 50(1)-50(n) and accessing cryptographic keys stored on the plurality of hardware security system(s) 50(1)-50(n). The application(s) can be implemented as components of other applications. Further, the application(s) can be implemented as operating system extensions, plugins, or the like.

Thus, the technology disclosed herein is not to be construed as being limited to a single environment and other configurations and architectures are also envisaged. For example, the plurality of hardware security system(s) 50(1)-50(n) depicted in FIGS. 1A and 1B and can operate within network traffic manager apparatus 20 rather than as a stand-alone server communicating with network traffic manager apparatus 20 via the communication network(s) 30. In this example the plurality of hardware security system(s) 50(1)-50(n) operate within the memory 22 of the network traffic manager apparatus 20.

While the network traffic manager apparatus 20 is illustrated in this example as including a single device, the network traffic manager apparatus 20 in other examples can include a plurality of devices each with processors each processor with one or more processing cores that implement one or more steps of this technology. In these examples, one or more of the devices can have a dedicated communication interface or memory. Alternatively, one or more of the devices can utilize the memory, communication interface, or other hardware or software components of one or more other communicably coupled of the devices. Additionally, one or more of the devices that together comprise network traffic manager apparatus 20 in other examples can be standalone devices or integrated with one or more other devices or applications, plurality of hardware security systems 50(1)-50(n) or, the network traffic manager apparatus 20, or applications coupled to the communication network(s), for example. Moreover, one or more of the devices of the network traffic manager apparatus 20 in these examples can be in a same or a different communication network 30 including one or more public, private, or cloud networks, for example.

Although an exemplary network traffic management system 10 with the plurality of client computing devices 40(1)-40(n), the network traffic manager apparatus 20, and the plurality of hardware security system(s) 50(1)-50(n), and communication networks 30 are described and illustrated herein, other types and numbers of systems, devices, components, and elements in other topologies can be used. It is to be understood that the systems of the examples described herein are for exemplary purposes, as many variations of the specific hardware and software used to implement the examples are possible, as will be appreciated by those skilled in the relevant art(s).

Further, each of the systems of the examples may be conveniently implemented using one or more general purpose computer systems, microprocessors, digital signal processors, and micro-controllers, programmed according to the teachings of the examples, as described and illustrated herein, and as will be appreciated by those of ordinary skill in the art.

One or more of the components depicted in the network traffic management system, such as the network traffic manager apparatus 20, the plurality of client computing devices 40(1)-40(n), and the plurality of hardware security system(s) 50(1)-50(n), for example, may be configured to operate as virtual instances on the same physical machine. In other words, one or more of network traffic manager apparatus 20, the plurality of client computing devices 40(1)-40(n), or the plurality of hardware security system(s) 50(1)-50(n) illustrated in FIGS. 1A, 1B and 4A-4I may operate on the same physical device rather than as separate devices communicating through a network as depicted in FIGS. 1A and 1B. There may be more or fewer plurality of client computing devices 40(1)-40(n), network traffic manager apparatus 20, or the plurality of hardware security system(s) 50(1)-50(n) than depicted in FIGS. 1A and 1B. The plurality of client computing devices 40(1)-40(n), the plurality of hardware security systems 50(1)-50(n) could be implemented as applications on network traffic manager apparatus 20.

In addition, two or more computing systems or devices can be substituted for any one of the systems or devices in any example. Accordingly, principles and advantages of distributed processing, such as redundancy and replication also can be implemented, as desired, to increase the robustness and performance of the devices and systems of the examples. The examples may also be implemented on computer system(s) that extend across any suitable network using any suitable interface mechanisms and traffic technologies, including by way of example only tele-traffic in any suitable form (e.g., voice and modem), wireless traffic media, wireless traffic networks, cellular traffic networks, G3 traffic networks, Public Switched Telephone Network (PSTNs), Packet Data Networks (PDNs), the Internet, intranets, and combinations thereof.

The examples may also be embodied as a non-transitory computer readable medium having instructions stored thereon for one or more aspects of the technology as described and illustrated by way of the examples herein, which when executed by a processor (or configurable hardware), cause the processor to carry out the steps necessary to implement the methods of the examples, as described and illustrated herein.

An example of a method for migrating keys will now be described with reference to FIGS. 1-4. First in step 305, the network traffic manager apparatus 20 receives a key migration request from one of the plurality of client computing devices 40(1)-40(n) as illustrated in FIG. 4A, although the network traffic manager apparatus 20 can receive other types or amounts of requests. The key migration request is a request to migrate an original key 54 from a first hardware security system 50(1) to a second hardware security system 50(2). The original key 54 can be a secret such as a stored password or other sensitive values or secret values. The original key 54 can also be a cryptographic key and be a secret such as a stored password or other sensitive values. In the art, it is understood that this migration can be conducted with any of the plurality of hardware security systems 50(1)-50(n) and can be achieved with other methods. The plurality of hardware security systems 50(1)-50(n) can include a plurality of hardware security modules. The plurality of hardware security systems 50(1)-50(n) can be computer hardware and/or software (e.g., a computing device) configured to store cryptographic keys, perform cryptographic operations (such as generating keys, encrypting data, and decrypting data), and enforce a security policy for using and/or accessing the cryptographic keys. The plurality of hardware security systems 50(1)-50(n) can include a physical enclosure that reduces a likelihood of observing and/or tampering with sensitive data, such as private keys of the plurality of hardware security systems 50(1)-50(n). The enclosure can cover potential electrical probe points and display visible damage if the enclosure is tampered with. By way of example, the network traffic manager apparatus 20 can begin a migration request of migrating an original key 54 from a first hardware security system 50(1) to a second hardware security system 50(2) by first sending a request to generate a key protection keypair in the second hardware security system 50(2). By way of example, the key protection keypair can include a private key 53(2) and a public key 55(2). Information that is encrypted with the private key 53(2) can be decrypted with the corresponding public key 55(2). Information that is encrypted with the public key 55(2) can be decrypted with the corresponding private key 53(2). A key can be a cryptographic key, by way of example. Cryptographic keys can be values (e.g., 128-or 256-byte numbers) that are selected based on their cryptographic properties.

In step 310, the network traffic manager apparatus 20 receives a public key 53(2) from a second hardware security system 50(2) as illustrated in FIG. 4B. The public key 53(2) can be generated as a result of sending a request to the second hardware security system 50(2) to generate a keypair, the keypair including the public key 53(2) and the private key 55(2) in the second hardware security system 50(2). The received public key 53(2) from the second hardware security system 50(2) can be sent to the first hardware security system 50(1). In the art, it is understood that this sending and receiving can be conducted with any of the plurality of hardware security systems 50(1)-50(n) and can be achieved with other methods. Any hardware security system of the plurality of hardware security systems 50(1)-50(n) can have different APIs with different functions that perform tasks related to keys. Apart from generating keypairs, as described above, plurality of hardware security systems 50(1)-50(2) can respond to requests from a network traffic manager apparatus 20 to send and receive keys to the traffic manager apparatus 20. The plurality of hardware security systems 50(1)-50(n) can also adhere to Public Key Cryptography Standards (PKCS). PKCS can be a class of public-key cryptography standards. PKCS#11 (also referred to as Cryptoki) can be a specific platform-independent API for interfacing to the plurality of hardware security systems 50(1)-50(n), which can define data types, functions, and other components that are available to applications that implement the PKCS#11 standard. The data types can represent an item, such as a cryptographic key, that is stored on the plurality of hardware security systems 50(1)-50(n). In some examples, the specific platform-independent API can implement different methods and functions of importing, exporting, sending, receiving, encrypting, and decrypting the cryptographic keys.

In step 315, the network traffic manager apparatus 20 sends a request to the first hardware security system 50(1) to generate a symmetric key 56(1) using the public key 53(2) generated by the second hardware security system 50(2) as illustrated in FIG. 4C. As a result of receiving the request from the network traffic manager apparatus 20, the first hardware security system 50(1) creates a symmetric key 56(1) using the public key 53(2) in the first hardware security system 50(1). By way of example, cryptographic keys can be symmetric keys or asymmetric keys. Asymmetric keys can include a group of a private key and public key(s). In this example, the symmetric key 56(1) can be a type of encryption where only one key is used to both encrypt and decrypt information. When a symmetric key is used to encrypt information, the same symmetric key can be used to decrypt the information. Encryption can be the reversible transformation of clear or unencrypted information (e.g., text, plaintext, or data) into data that is computationally infeasible to understand except for the sender or the intended recipient of the information. Decryption can be the reversal of the encryption process, where encrypted information is transformed into unencrypted information. Encryption and decryption can be performed using one or more cryptographic algorithms that can include one or more cryptographic operations. Cryptographic operations can include encoding information using a cryptographic key, decoding information using a cryptographic key, and generating a cryptographic key.

In step 320, the network traffic manager apparatus 20 receives an encrypted symmetric key 56(2) of the first hardware security system 50(1) as illustrated in FIG. 4D. The encrypted symmetric key 56(2) can be created by encrypting the symmetric key 56(1) with the public key 53(2) from the second hardware security system 50(2). In this example, the public key 53(2) is used to encrypt the symmetric key 56(1) to make the encrypted symmetric key 56(2) computationally infeasible to understand in the cleartext format outside of the plurality of hardware security systems 50(1)-50(n).

In step 325, the network traffic manager apparatus 20 sends the received encrypted symmetric key 56(2) to the second hardware security system 50(2) as illustrated in FIG. 4E. To decrypt the encrypted symmetric key 56(2), the private key 55(2) can be used to reverse the encryption process. By example, private and public keys can be mathematically tied together, so that the corresponding private key can only decrypt the information encrypted using the public key. In this example, because the symmetric key 56(1) in the first hardware security system 50(1) was encrypted using the public key 53(2) from the second hardware security system 50(2), the private key 55(2) in the second hardware security system 50(2) can decrypt the encrypted symmetric key. It is understood that the symmetric key 56(1) does not need to be immediately decrypted after the network traffic manager apparatus 20 sends the received encrypted symmetric key 56(2) to the second hardware security system 50(2). The encrypted symmetric key 56(2) can be decrypted at any time and does not need to occur immediately following step 325. FIG. 4F illustrates the symmetric key 56(1) after it has been decrypted with the private key 55(2).

In step 330, the network traffic manager apparatus 20 sends a request to

the first hardware security system 50(1) to encrypt an original key 54 using the symmetric key 56(1) of the public key 53(2) from the second hardware security system 50(2) as illustrated in FIG. 4F. By example, the original key 54 can be the key that the operation is migrating from the first hardware security system 50(1) to the second hardware security system 50(2). The original key can include clear or unencrypted information (e.g., text, plaintext, or data). In some embodiments, the original key 54 can be a key in a keypair. The original key 54(2) can be encrypted using the symmetric key 56(1) or the public key 53(2) from the second hardware security system 50(2).

In step 335, the network traffic manager apparatus 20 receives the encrypted original key 54(2) from the first hardware security system 50(1) as illustrated in FIG. 4G. In step 340, the network traffic manager apparatus 20 sends the received encrypted original key 54(2) to the second hardware security system 50(2) as illustrated in FIG. 4H. By using this method, the original key 54 has been migrated to the second security server 50(2) encrypted, without exposing the cleartext format of the original key 54 outside of the plurality of hardware security systems 50(1)-50(n).

Then, in step 345, the network traffic manager apparatus 20 sends a decryption request to the second hardware security system 50(2) to decrypt the sent encrypted original key 54(2) using the sent encrypted symmetric key 56(2) and the exemplary flow ends at step 350. As illustrated, the network traffic manager apparatus 20 provided a key migration service while performing requests and actions external to the plurality of hardware security systems 50(1)-50(n). The key migration service provided by the network traffic manager 20 or comparable technologies, can communicate with all hardware security systems 50(1)-50(n) provided by the major Cloud Providers. The key migration service is also secure because the service does not have the data required to decrypt the original key, because the key migration does not have access to the private keys in the plurality of hardware security systems 50(1)-50(n).

Having thus described the basic concept of the technology, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the technology. Additionally, the recited order of processing elements or sequences, or the use of numbers, letters, or other designations, therefore, is not intended to limit the claimed processes to any order except as may be specified in the claims. Accordingly, the technology is limited only by the following claims and equivalents thereto.

1. A method for migrating a key, the method implemented by one or more network traffic management apparatuses, server devices, or client devices, the method comprising:
receiving an encrypted symmetric key from a first hardware security system, wherein the encrypted symmetric key was generated by encrypting, using a public key generated from a second hardware security system, a symmetric key generated by the first hardware security system, and wherein the generated public key is transmitted to the first hardware security system prior to the encryption;
sending the received encrypted symmetric key to the second hardware security system;
receiving an encrypted original key from the first hardware security system after sending the encrypted symmetric key to the second hardware security system, wherein an original key was encrypted using the symmetric key;
sending the received encrypted original key to the second hardware security system; and
completing a migration of the original key from the first hardware security system to the second hardware security system when the second hardware security system decrypts the sent encrypted original key using the sent encrypted symmetric key.

2. The method as set forth in claim 1, further comprising sending a decryption request to the second hardware security system to decrypt the encrypted symmetric key sent to the second hardware security system using a private key corresponding to the generated public key prior to the decrypting of the sent encrypted original key.

3. The method as set forth in claim 2, wherein the public key and the private key are generated by the second hardware security system to migrate the original key from the first hardware security system to the second hardware security system.

4. The method as set forth in claim 2, wherein the private key is not sent to the first hardware security system to migrate the original key from the first hardware security system to the second hardware security system.

5. The method as set forth in claim 1, wherein the original key is a cryptographic key, a stored password, or a secret value.

6. A non-transitory computer readable medium having stored thereon instructions for migrating a key comprising executable code which when executed by one or more processors, causes the one or more processors to:
receive an encrypted symmetric key from a first hardware security system, wherein the encrypted symmetric key was generated by encrypting, using a public key generated from a second hardware security system, a symmetric key generated by the first hardware security system, and wherein the generated public key is transmitted to the first hardware security system prior to the encryption;
send the received encrypted symmetric key to the second hardware security system;
receive an encrypted original key from the first hardware security system after sending the encrypted symmetric key to the second hardware security system, wherein an original key was encrypted using the symmetric key;
send the received encrypted original key to the second hardware security system; and
complete a migration of the original key from the first hardware security system to the second hardware security system when the second hardware security system decrypts the sent encrypted original key using the sent encrypted symmetric key.

7. The medium as set forth in claim 6, wherein the one or more processors are further configured to be capable of executing the programmed instructions stored in the memory to send a decryption request to the second hardware security system to decrypt the encrypted symmetric key sent to the second hardware security system using a private key corresponding to the generated public key prior to the decrypting of the sent encrypted original key.

8. The medium as set forth in claim 7, wherein the public key and the private key are generated by the second hardware security system to migrate the original key from the first hardware security system to the second hardware security system.

9. The medium as set forth in claim 7, wherein the private key is not sent to the first hardware security system to migrate the original key from the first hardware security system to the second hardware security system.

10. The medium as set forth in claim 6, wherein the original key is a cryptographic key, a stored password, or a secret value.

11. A network traffic manager device, comprising memory comprising programmed instructions stored in the memory and one or more processors configured to be capable of executing the programmed instructions stored in the memory to:
receive an encrypted symmetric key from a first hardware security system, wherein the encrypted symmetric key was generated by encrypting, using a public key generated from a second hardware security system, a symmetric key generated by the first hardware security system, and wherein the generated public key is transmitted to the first hardware security system prior to the encryption;
send the received encrypted symmetric key to the second hardware security system;
receive an encrypted original key from the first hardware security system after sending the encrypted symmetric key to the second hardware security system, wherein an original key was encrypted using the symmetric key;
send the received encrypted original key to the second hardware security system; and
complete a migration of the original key from the first hardware security system to the second hardware security system when the second hardware security system decrypts the sent encrypted original key using the sent encrypted symmetric key.

12. The device as set forth in claim 11, wherein the one or more processors are further configured to be capable of executing the programmed instructions stored in the memory to send a decryption request to the second hardware security system to decrypt the encrypted symmetric key sent to the second hardware security system using a private key corresponding to the generated public key prior to the decrypting of the sent encrypted original key.

13. The device as set forth in claim 12, wherein the public key and the private key are generated by the second hardware security system to migrate the original key from the first hardware security system to the second hardware security system.

14. The device as set forth in claim 12, wherein the private key is not sent to the first hardware security system to migrate the original key from the first hardware security system to the second hardware security system.

15. The device as set forth in claim 11, wherein the original key is a cryptographic key, a stored password, or a secret value.

16. A network traffic management system, comprising traffic management apparatuses, server devices, or client devices, the network traffic management system comprising memory comprising programmed instructions stored thereon and one or more processors configured to be capable of executing the stored programmed instructions to:
receive an encrypted symmetric key from a first hardware security system, wherein the encrypted symmetric key was generated by encrypting, using a public key generated from a second hardware security system, a symmetric key generated by the first hardware security system, and wherein the generated public key is transmitted to the first hardware security system prior to the encryption;
send the received encrypted symmetric key to the second hardware security system;
receive an encrypted original key from the first hardware security system after sending the encrypted symmetric key to the second hardware security system, wherein an original key was encrypted using the symmetric key;
send the received encrypted original key to the second hardware security system; and
complete a migration of the original key from the first hardware security system to the second hardware security system when the second hardware security system decrypts the sent encrypted original key using the sent encrypted symmetric key.

17. The network traffic management system as set forth in claim 16, wherein the one or more processors are further configured to be capable of executing the programmed instructions stored in the memory to send a decryption request to the second hardware security system to decrypt the encrypted symmetric key sent to the second hardware security system using a private key corresponding to the generated public key prior to the decrypting of the sent encrypted original key.

18. The network traffic management system as set forth in claim 17, wherein the public key and the private key are generated by the second hardware security system to migrate the original key from the first hardware security system to the second hardware security system.

19. The network traffic management system as set forth in claim 17, wherein the private key is not sent to the first hardware security system to migrate the original key from the first hardware security system to the second hardware security system.

20. The network traffic management system as set forth in claim 16, wherein the original key is a cryptographic key, a stored password, or a secret value.
